(19) United States
(12) Patent Application Publication
(10) Pub. No.: US 2020/0260689 A1
(43) Pub. Date: Aug. 20, 2020

(54) NAIL GRINDER FOR PET ANIMALS

(71) Applicant: Naftoli Jacobowitz, Brooklyn, NY (US)

(72) Inventor: Naftoli Jacobowitz, Brooklyn, NY (US)

(21) Appl. No.: 16/278,063

(22) Filed: Feb. 16, 2019

(51) Int. Cl. A01K 13/00

(52) U.S. Cl. CPC A01K 13/00

(57) ABSTRACT

Disclosed is a nail grinder for grinding nails of a pet animal. The nail grinder includes one or more nail grinding stones that are housed in a grinding stone cap of the nail grinder. The nail grinder is turned ON or turned OFF by a user using a power switch of the nail grinder. The nail grinder further includes a light source switch for controlling ON-OFF of an LED light with respect to at least a front part, a rear part, or an entirety of the LED light.

### CROSS-REFERENCE TO RELATED PATENT DOCUMENTS

This patent application claims the benefit of priority of U.S. Provisional Application No. 62/660,950, entitled “PET GRINDER HAVING HALO-ILLUMINATION LIGHTING,” filed Apr. 21, 2018, which are hereby incorporated herein by reference in its entirety

### FIELD OF THE INVENTION

The present invention relates generally to handheld devices, and, more particularly, to a nail grinder for pet animals.

### BACKGROUND

Pet animals are often frightened or made uncomfortable by tools used for grooming. Thus, grooming pet animals can be a difficult task. Frightened pet animals may move erratically in various directions in an effort to escape the grooming procedure, and this erratic movement may be dangerous to a pet animal or a groomer. For example, the erratic movement by a pet animal may cause a cutting surface of the grooming tool to contact sensitive areas of a pet animal or groomer, which in turn may harm the pet animal or the groomer.

Furthermore, cutting or trimming nails of pet animals can be particularly challenging. Grooming devices are commonly used to trim the nails of pet animals. Generally, a pair of scissors or nail clippers are used to trim the nails or claws of pet animals. Scissors and nail clippers have serious setbacks including the potential of causing serious pain and injury to pet animals as well as the groomer if the nails or claws are clipped too much. If the groomer is not careful and experienced, the groomer can end up cutting sensitive tissue or skin [non-cuttable parts] on pet animals, which can cause extreme pain and bleeding to pet animals.

In light of the foregoing, there exists a need for a technical and reliable solution that solves the above-mentioned problems and presents an improved grooming device for the pet animals that is friendly and harm resistant to the pet animals.

### BRIEF SUMMARY

It is an objective of the present invention to provide a nail grinder for pet animals. The nail grinder disclosed in the present invention includes at least one power switch (such as a three position switch) that can be operated by a user to control the rotational speed of a nail grinding stone of the nail grinder. The three position switch can be operated by the user to switch between three positions. In a first position of the three position switch, the nail grinder is in OFF state (i.e., the nail grinding stone does not rotate), and thus, the nail grinding stone cannot be used for grinding nails of a pet animal. In a second position of the three position switch, the nail grinder is in ON state (i.e., the nail grinding stone rotates), and thus, the nail grinding stone may be used for grinding the nails of the pet animal. In this position (i.e., the second position), the nail grinding stone operates at a medium speed. In a third position of the three position switch, the nail grinder is in ON state (i.e., the nail grinding stone rotates), and thus, the nail grinding stone may be used for grinding the nails of the pet animal. In this position (i.e., the third position), the nail grinding stone operates at a high speed.

In an embodiment, the nail grinding stone is a removable grinding stone that can be removed and replaced with different grits of grinding stones. The nail grinding stone may be housed in a grinding stone housing (i.e., a grinding stone cap) of the nail grinder.

In addition, the nail grinder further includes a light source portion having a light source for illuminating a nail grinding surface of a nail or claw of the pet animal. The nail grinder embodiment having the light source for illuminating the nail or claw cutting surface is very advantageous so that the nail or claw surfaces to be trimmed are more clearly visible and distinguishable from the sensitive portions of a pet animal's paws or skin. One preferred nail grinder embodiment further includes a light source switch. The light source switch may be operated by the user to turn ON or turn OFF one or more lights, such as one or more light emitting diodes (“LED's”) located in the light source portion of the nail grinder for illuminating the trimming surface of a pet animal's nails or claws. One such embodiment of the light source switch utilizes four modes of operation. In a first mode, when the light source switch is pressed by the user, a front half of the light source portion emits light such as by means of one or more LED's with halogen light. In a second mode, when the light source switch is pressed by the user, a rear half of the light source portion emits light such as by means of one or more LED's with halogen light. In a third mode, when the light source switch is pressed by the user, the entire light source portion emits light such as by means of one or more LED's with halogen light. In a fourth mode, when the light source switch is pressed by the user, the light source portion is turned OFF and does not emit any light.

These and other features and advantages of the present invention will become apparent from the detailed description below, in light of the accompanying drawings.

### BRIEF DESCRIPTION OF THE ACCOMPANYING DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of various examples. It is expressly understood, however, that the drawings are for the purpose of illustration and description only and are not intended as a definition of the limits of the invention. Embodiments of this invention will now be described by way of example in association with the accompanying drawings in which:

FIGS. 1A and 1B illustrate a front view and a rear view of a nail grinder, in accordance with an embodiment of the present invention;

FIGS. 2A and 2B illustrate a left view and a right view of the nail grinder, in accordance with an embodiment of the present invention:

FIGS. 3A and 3B illustrate a top view and a bottom view of the nail grinder, in accordance with an embodiment of the present invention;

FIG. 4 illustrates an isometric view of the nail grinder, in accordance with an embodiment of the present invention;

FIG. 5 illustrates a top isometric view of the nail grinder, in accordance with an embodiment of the present invention; and

FIG. 6 illustrates a blown-up version of the nail grinder, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the Figures are illustrated for simplicity and clarity and are not necessarily drawn to scale. For example, the dimensions of some of the elements in the Figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of components, which constitutes a nail grinder for pet animals. Accordingly, the components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items.

Techniques consistent with the present invention provide, among other features, a nail grinder for grinding nails of pet animals. Unless stated otherwise, terms such as “first” and “second” are used to arbitrarily distinguish between the elements or entities. Thus, these terms are not necessarily intended to indicate temporal or other prioritization of such elements or priorities. While various exemplary embodiments of the disclosed systems and methods have been described above, it should be understood that they have been presented for purposes of example only, and not limitations. It is not exhaustive and does not limit the invention to the precise form disclosed. Modifications and variations are possible in light of the above teachings or may be acquired from practicing of the invention, without departing from the breadth or scope.

The pet nail grinder will now be described with reference to the accompanying drawings, which should be regarded as merely illustrative without restricting the scope and ambit of the present invention.

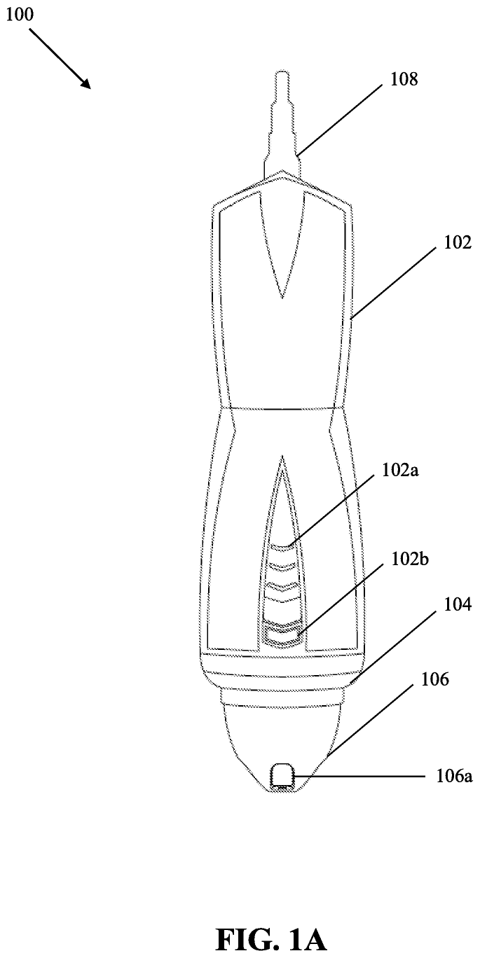

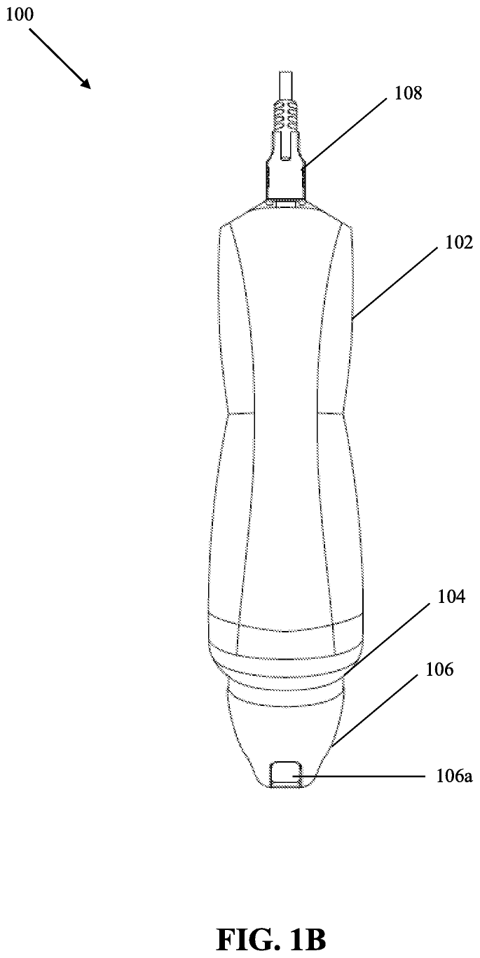

FIG. 1A illustrates a front view of a nail grinder 100, in accordance with an embodiment of the present invention. The nail grinder 100 includes a plurality of portions such as a body portion 102, a light source portion 104, and a grinding stone portion 106. In an embodiment, the body portion 102, the light source portion 104, and the grinding stone portion 106 are removably assembled or attached together to obtain the nail grinder 100.

In an embodiment, the body portion 102 (such as an upper body portion of the nail grinder 100) may be made of various materials, such as, but not limited to, plastic, aluminum, copper, steel or iron. The body portion 102 may include a power switch assembly 102a on its top i.e., on a front part of the body portion 102 as shown in FIG. 1A. The power switch assembly 102a may include at least one power switch. The power switch may be an electrical switch, an electronic switch, a mechanical switch, or a combination thereof. In an exemplary embodiment, the power switch may be operated to activate or deactivate (i.e., to turn ON or turn OFF) the nail grinder 100. The power switch may also be operated to control the rotational speed of at least one nail grinding stone of the nail grinder 100. The power switch may be operated along three positions such as a first position, a second position, and a third position. In the first position of the power switch, the nail grinder 100 remains in OFF condition (i.e., in deactivated mode), and the nail grinding stone does not rotate. In the second position of the power switch, the nail grinder 100 is turned ON (i.e., in activated mode), and the nail grinding stone rotates and operates at a medium speed. In the third position of the power switch, the nail grinder 100 remains turned ON, and the nail grinding stone rotates and operates at a high speed. Thus, the power switch of the power switch assembly 102a may be operated by a user to switch between at least the first position, the second position, and the third position to operate the nail grinder 100. In another exemplary embodiment, the power switch assembly 102a may include three power switches such as a first power switch, a second power switch, and a third power switch. The first power switch may be operated to turn OFF the nail grinder 100. The second power switch may be operated to turn ON the nail grinder 100 in which the nail grinding stone operates and rotates at a medium speed. The third power switch may be operated to turn ON the nail grinder 100 and in which the nail grinding stone operates and rotates at a high speed.

In an embodiment, the body portion 102 may further include a light source switch 102b on its top i.e., on a front part of the body portion 102 as shown in FIG. 1A. The light source switch 102b may be an electrical switch, an electronic switch, a mechanical switch, or a combination thereof. The light source switch 102b may be operated by the user to turn ON or turn OFF a light source, such as one or more light emitting diodes (“LED's” or a series of LED's) included in the light source portion 104 of the nail grinder 100. The light source switch 102b may be associated with at least four modes of operations. Each mode of operation may be activated by pressing or operating the light source switch 102b. In one example, with a first press of the light source switch 102b by the user, a front half of the light source portion 104 (as shown in FIG. 1A) is illuminated (i.e., turns ON) and emits halogen light by means of one or more LED's (i.e., the front half of a panel of LED's lights up). Further, with a second press of the light source switch 102b by the user, a rear half of the light source portion 104 (as shown in FIG. 1B) is illuminated (i.e., turns ON) and emits halogen light by means of one or more LED's (i.e., the back half of a panel of LED's lights up). Further, with a third press of the light source switch 102b by the user, the entire light source portion 104 is illuminated (i.e., turns ON) and emits halogen light by means of one or more LED's (i.e., the entire panel of LED's lights up). Further, with a fourth press of the light source switch 102b by the user, the light source portion 104 is no longer illuminated (i.e. turns OFF) and does not emit halogen light from any of the one or more LED's. In other embodiments, the light source portion 104 may be comprised of other light emitting means, such as incandescent or fluorescent type light sources.

In an embodiment, the grinding stone portion 106 (such as a lower body of the nail grinder 100) is a grinding stone housing (i.e., a grinding stone cap such as a cone-shaped cap) that houses one or more nail grinding stones such as a grinding stone 106a. The grinding stone 106a may be made of a coarse, abrasive material, such as, but not limited to, sand, aluminum oxide, ceramic, silicon carbide, or zirconium oxide. The grinding stone 106a may have different grades of grit ranging from course to buff on the same stone. Alternatively, the grinding stone portion 106 may include different grinding stones (such as the grinding stone 106a) for different grades of grit ranging from course to buff. The grinding stone 106a may be a concave grinding stone, a convex grinding stone, or a combination thereof, and may be removably fixed or attached to an inner connector (such as a clip or a holding means such as a socket). The grinding stone 106a may be removable as well as replaceable. In an embodiment, the rotational speed of the grinding stone 106a may be controlled by means of one or more motors that are housed or positioned inside a nail grinder body portion (such as the body portion 102) of the nail grinder 100. The one or more motors may be removably positioned inside the nail grinder 100 to drive the grinding stone 106a. For example, when the power switch of the power switch assembly 102a is turned ON (i.e., the power switch is at the second position or the third position), the one or more motors are also turned ON, which in turn rotates the grinding stone 106a. In an embodiment, the one or more motors may be configured to operate at two speeds i.e., at the medium speed and at the high speed. The speed of the one or more motors may be controlled by operating the power switch of the power switch assembly 102a. For example, when the power switch is at the second position or at the third position, the one or more motors are turned ON and accordingly operates at the defined medium speed or the defined high speed, which in turn rotates the grinding stone 106a at the medium speed or at the high speed.

In FIG. 1A, there is further shown an electrical charging or operating cable such as a power chord 108 that is removably fixed to an input power supply terminal of the nail grinder 100. The input power supply terminal may be located at the top of the nail grinder 100. In one example, the power chord 108 may be utilized by a user to charge at least one battery (not shown) housed or positioned with the nail grinder body portion (such as the body portion 102) of the nail grinder 100. When connected, the power chord 108 may draw an electrical power from a mains power supply and supply the drawn electrical power to the battery of the nail grinder 100 for charging the battery. Upon partial charging or complete charging of the battery of the nail grinder 100, the user may utilize the nail grinder 100 for grinding nails of a pet animal. In another example, the power chord 108 may be utilized by the user to directly supply the electrical power from the mains power supply to nail grinder 100, and the user may utilize the nail grinder 100 for grinding nails of the pet animal. In another example, the power chord 108 may be utilized by the user for charging the battery of the nail grinder 100 and grinding nails of the pet animal at the same time.

FIG. 1B illustrates a rear view of the nail grinder 100, in accordance with an embodiment of the present invention. In FIG. 1B, a rear part of the body portion 102, a rear part of the light source portion 104, and a rear part of the grinding stone portion 106 have been shown.

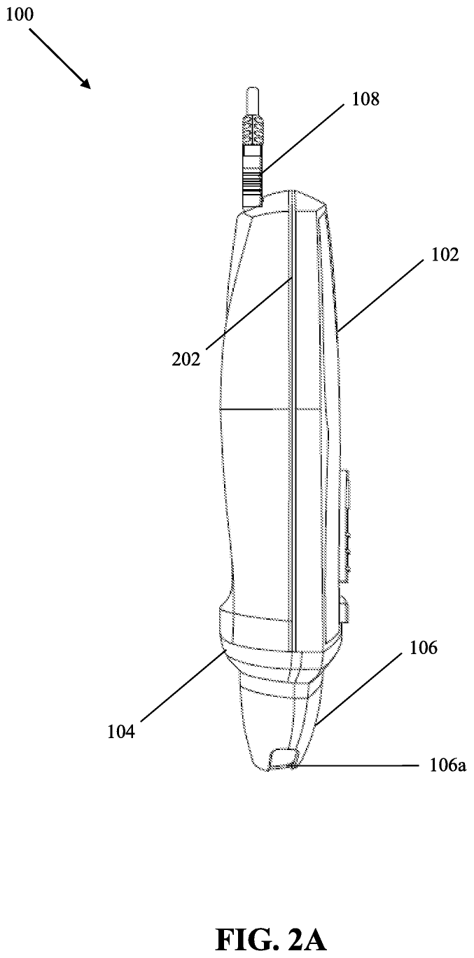

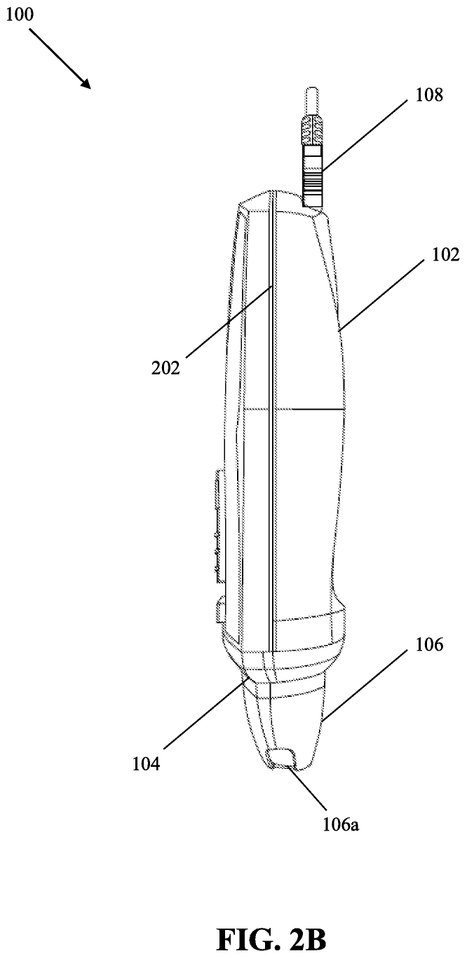

FIGS. 2A and 2B illustrate a left view and a right view of the nail grinder 100, respectively, in accordance with an embodiment of the present invention. As shown in the left view and the right view, the nail grinder 100 includes an axis 202 along which the rear half of the body portion 102 is removably fixed to the front half of the body portion 102. In one example, the rear half of the body portion 102 may be removed from the front half of the body portion 102 to replace the battery or the one or more motors of the nail grinder 100. In another example, the rear half of the body portion 102 may be removed from the front half of the body portion 102 to perform maintenance work with respect to at least the battery or the one or more motors of the nail grinder 100.

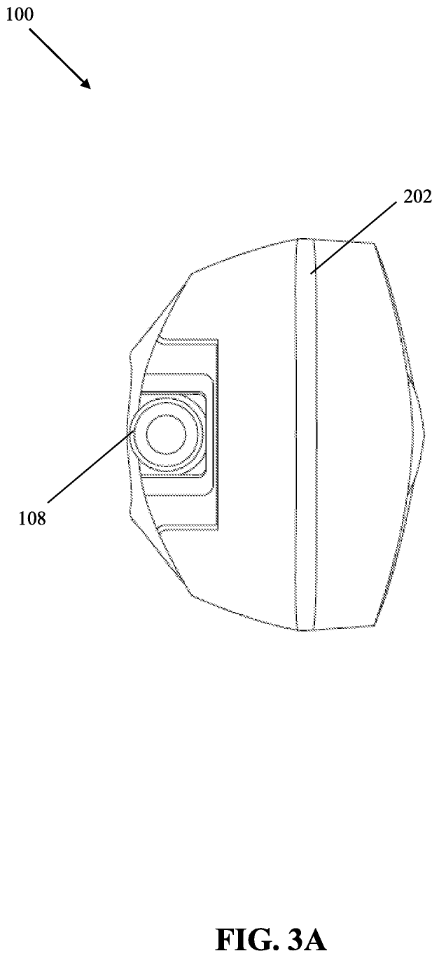

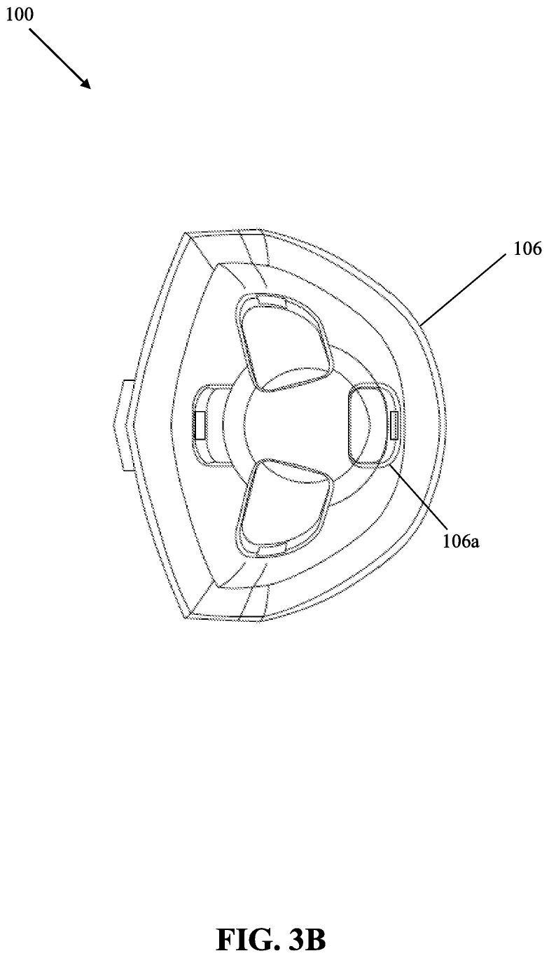

FIGS. 3A and 3B illustrate a top view and a bottom view of the nail grinder 100, in accordance with an embodiment of the present invention. In the top view of the nail grinder 100 as shown in FIG. 3A, the power chord 108 has been shown as removably fixed or attached to the input power supply terminal of the nail grinder 100. The other end of the power chord 108 may be connected to the mains power supply to provide electrical power to the battery of the nail grinder 100 for charging the battery or to the one or more motors of the nail grinder 100 for producing the rotational power, which in turn controls and manages the rotation of the grinding stone 106a.

In the bottom view of the nail grinder 100 as shown in FIG. 3B, the grinding stone portion 106 has been shown that houses the one or more grinding stones such as the grinding stone 106a. The grinding stone 106a may be made of a coarse, abrasive material, such as, but not limited to, sand, aluminum oxide, ceramic, silicon carbide or zirconium oxide. The grinding stone 106a may have different grades of grit ranging from course to buff on the same stone. Alternatively, the grinding stone portion 106 may include different grinding stones (such as the grinding stone 106a) for different grades of grit ranging from course to buff. The grinding stone 106a may be a concave grinding stone, a convex grinding stone, or a combination thereof, and may be removably fixed or attached to the inner connector. When the one or more motors are tuned ON, the one or more grinding stones (such as the grinding stone 106a that is physically connected to a shaft of the one or more motors by means of one or more internal channels) starts rotating, and thus, the one or more grinding stones may be further used for grinding nails of the pet animals such as a pet dog, a pet cat, or a pet bird. The direction of rotation of the one or more grinding stones (such as the grinding stone 106a) may be proportional to the direction of rotation of the shaft of the one or more motors. For example, if a shaft of a motor is rotating in clockwise direction, then the grinding stone 106a may rotate in the clockwise direction. Similarly, if a shaft of a motor is rotating in anti-clockwise direction, then the grinding stone 106a may rotate in the anti-clockwise direction. Alternatively, the nail grinder 100 may include a rotation controlling switch (not shown) that may be operated by the user to control the direction of rotation of the one or more grinding stones (such as the grinding stone 106a). Alternatively, the nail grinder 100 may rotate in all direction due to the rotation of the shaft of the motor.

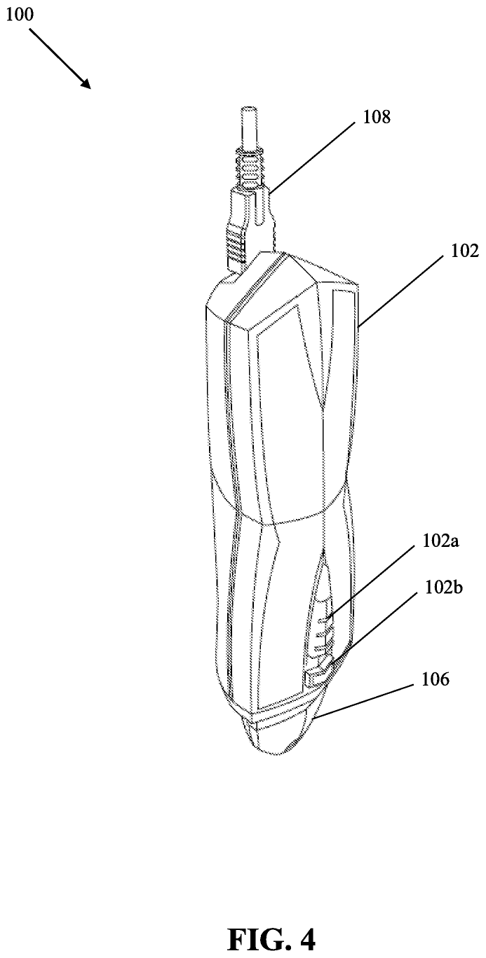

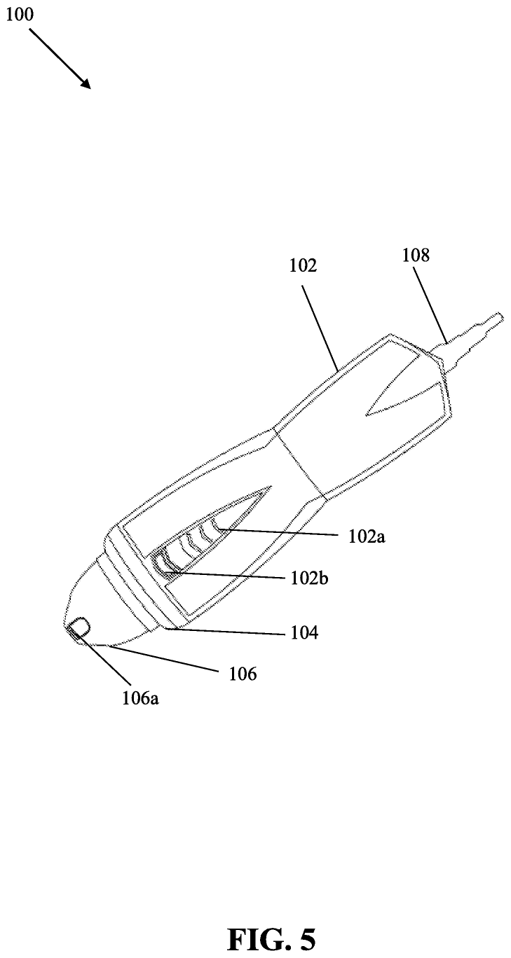

FIG. 4 illustrates an isometric view of the nail grinder 100, in accordance with an embodiment of the present invention. The isometric view of the nail grinder 100 shows the body portion 102 including the power switch assembly 102a and the light source switch 102b, the grinding stone portion 106, and the power chord 108. FIG. 5 illustrates a top isometric view of the nail grinder 100, in accordance with an embodiment of the present invention. The isometric view of the nail grinder 100 shows the body portion 102 including the power switch assembly 102a and the light source switch 102b, the light source portion 104 including the front and rear halves having one or more LED's, the grinding stone portion 106 including the grinding stone 106a, and the power chord 108. The power chord 108 may be used for providing the power supply to the battery or the one or more motors of the nail grinder 100. In an embodiment, the power switch of the power switch assembly 102a may be operated by the user to activate or deactivate (i.e., turn ON or turn OFF) the nail grinder 100. For example, the nail grinder 100 is in OFF state when the power switch is in the first position. In the first position, there is no power supply to the one or more motors of the nail grinder 100. Thus, the one or more motors are in OFF state. As a result, the nail grinder 100 does not operate and the grinding stone 106a does not rotate. In the second position, the power is being drawn either from the battery or the mains power supply and the drawn power is supplied to the one or more motors of the nail grinder 100. Thus, the one or more motors are in ON state. As a result, the nail grinder 100 is turned ON and the grinding stone 106a rotates at the medium speed. In the third position, the power is being drawn either from the battery or the mains power supply and the drawn power is supplied to the one or more motors of the nail grinder 100. Thus, the one or more motors are in ON state. As a result, the nail grinder 100 is turned ON or remains in the ON state, and the grinding stone 106a rotates at the high speed. During the operation of the nail grinder 100, the grinding stone 106a may start rotating either in the clockwise direction or in the anti-clockwise direction. When the grinding stone 106a is rotating, the user may use the nail grinder 100 for grinding the nails of the pet animal.

In an embodiment, the nail grinder 100 further includes the light source switch 102b that may be operated by the user to turn ON or turn OFF one or more LED's included in the light source portion 104. There are four modes of operating the light source switch 102b. In a first mode, when the light source switch 102b is pressed by the user, the front half of the light source portion 104 emits halogen light such as by means of one or more halogen light emitting LED's. In a second mode, when the light source switch 102b is pressed by the user, the rear half of the light source portion 104 emits halogen light such as by means of one or more halogen light emitting LED's. In a third mode, when the light source switch 102b is pressed by the user, the entire light source portion 104 emits light from all sides or directions such as by means of one or more halogen light emitting LED's. In a fourth mode, when the light source switch 102b is pressed by the user, all of the LED's (such as all of the halogen light emitting LED's) are turned OFF and do not emit any light.

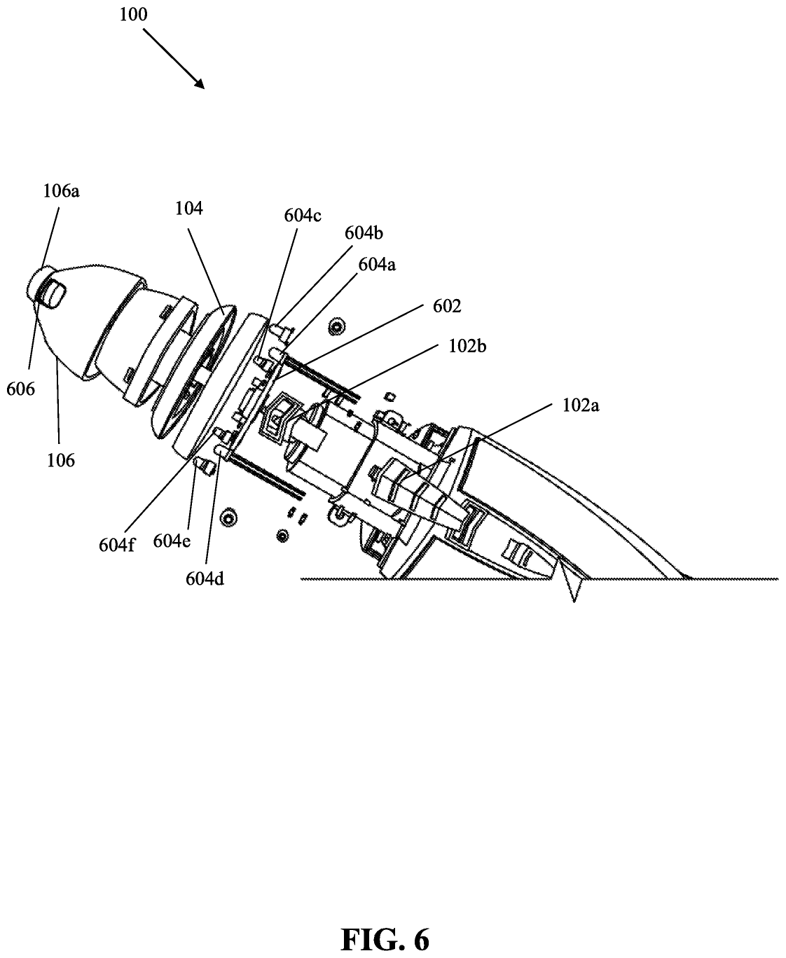

FIG. 6 illustrates a blown-up version of the nail grinder 100, in accordance with an embodiment of the present invention. The nail grinder 100 of FIG. 6 shows various components, for example, the power switch assembly 102a, the light source switch 102b, the light source portion 104, the grinding stone portion 106, and the grinding stone 106a. The nail grinder 100 of FIG. 6 shows an LED panel 602, LED's 604a-604f, and a clip 606. In an embodiment, the LED panel 602 may be used for holding the LED's 604a-604f. For example, the LED's 604a-604f are removably inserted into appropriate LED holes provided on the LED panel 602. Further, input terminals of each of the LED's 604a-604f are connected to a power supply unit such as the battery of the nail grinder 100. The ON-OFF of each of the LED's 604a-604f may be associated with one or more modes of operation of the light source switch 102b. For example, in the first mode of the light source switch 102b, only few of the LED's 604a-604f such as the LED's 604a and 604d are turned ON and thus the front half of the LED panel 602 (including the LED's 604a and 604d) is lighted. In the second mode of the light source switch 102b, only few of the LED's 604a-604f such as the LED's 604c and 604f are turned ON and thus the rear half of the LED panel 602 (including the LED's 604c and 604f) is lighted. In the third mode of the light source switch 102b, all of the LED's 604a-604f are turned ON and thus the entire LED panel 602 (including the LED's 604a-604f) is lighted. In the fourth mode of the light source switch 102b, all of the LED's 604a-604f are turned OFF and thus the entire LED panel 602 (including the LED's 604a-604f) does not emit light.

In an embodiment, the LED panel 602 also includes an opening at its center that allows a shaft of a motor (positioned inside the nail grinder 100) to pass through it and makes a contact with a cylindrical metallic material (such as a cylindrical brass pin, a cylindrical stainless steel pin, or any other appropriate material). For example, the shaft of the motor makes a physical contact with a first brass pin included inside the nail grinder 100, for example, in the grinding stone portion 106. The first brass pin further makes another physical contact with a second brass pin included inside the nail grinder 100, for example, in the grinding stone portion 106. The grinding stone 106a is removably attached (or removably makes physical contact) with the second brass pin. Thus, when the motor is turned ON, the shaft of the motor rotates, which in turn rotates the first brass pin and the second brass pin. Due to rotational motion of the second brass pin, the grinding stone 106a attached (or making physical contact) with the second brass pin also rotates. Due to the rotation of the grinding stone 106a and/or the physical contact of the grinding stone 106a with the second brass pin during the rotation, the vibration in the grinding stone 106a may be produced or generated. Thus, the grinding stone 106a may vibrate from one side to another side. Such rotation and/or vibration of the grinding stone 106a may be utilized for grinding the nails of the pet animals. In one example, the grinding stone 106a only rotates along its axis and is used for grinding the nails of the pet animal. In another example, the grinding stone 106a only vibrates from one side to another side and is used for grinding the nails of the pet animal. In yet another example, the grinding stone 106a rotates as well as vibrates and is used for grinding the nails of the pet animal.

In an embodiment, the grinding stone 106a may be removably attached to the clip 606 that holds the grinding stone 106a in its position. However, if required, the grinding stone 106a may be removed from the clip 606 and replaced with different grits of grinding stones.

Although particular embodiments of the invention have been described in detail for purposes of illustration, various modifications and enhancements may be made without departing from the spirit and scope of the invention.

What is claimed is:

1. A nail grinder for grinding nail or claw surfaces of pet animals, comprising:
a body portion, having at least one power switch and at least one light source switch,
a light source portion for illuminating a nail grinding surface of a nail or claw of a pet animal, and
a grinding stone portion having at least one removable grinding stone;
wherein said at least one power switch having at least three switch positions for controlling rotational speed of at said least one removable grinding stone of said nail grinder, and
said at least one light source switch having at least four modes for controlling illumination of said nail grinding surface of said pet animal.

2. The nail grinder of claim 1, wherein said at least one power switch, having a first position for switching off said least one removable grinding stone such that said least one removable grinding stone is in a motionless state, a second position for switching on said least one removable grinding stone such that said least one removable grinding stone operates at a medium speed, and a third position for switching on said least one removable grinding stone such that said least one removable grinding stone operates at a high speed.

3. The nail grinder of claim 1, wherein said at least one light source switch having said at least four modes for controlling illumination of said light source portion of said nail grinder, wherein a first mode illuminates one or more LED's located within a front half of said light source portion, a second mode illuminates one or more LED's located within a rear half of said light source portion, a third mode illuminates one or more LED's in both front and rear halves of said light source portion, and a fourth mode deactivates all LED's in said light source portion.

4. The nail grinder of claim 1, wherein said at least one power switch and said at least one light source switch are included on a front surface of an upper body portion of said body portion of said nail grinder.

5. The nail grinder of claim 3, wherein said front half of said light source portion comprises at least one halogen light emitting LED that is turned on when said at least one light source switch is in said first mode.

6. The nail grinder of claim 3, wherein said rear half of said light source portion comprises at least one halogen light emitting LED that is turned on when said at least one light source switch is in said second mode.

7. The nail grinder of claim 3, wherein an entire light source portion comprises one or more halogen light emitting LED's that are turned on when said at least one light source switch is in said third mode.

8. The nail grinder of claim 3 wherein an entire light source portion comprises one or more halogen light emitting LED's that are turned off when said at least one light source switch is in said fourth mode.

9. The nail grinder of claim 1, wherein at least one grinding stone is housed in a grinding stone housing and is removably fixed or attached to an inner connector of said grinding stone housing, such that said at least one grinding stone may be removed and replaced with another grinding stone.

10. The nail grinder of claim 1, wherein said light source portion is positioned between an upper body portion of said nail grinder and a grinding stone portion of said nail grinder, and wherein said grinding stone portion includes a grinding stone housing having said at least one removable grinding stone.

11. The nail grinder of claim 1, wherein said at least one removable grinding stone is driven by means of at least one motor positioned inside said nail grinder body portion, and wherein said at least one motor is powered by a battery also positioned within said nail grinder body portion.

12. The nail grinder of claim 1, wherein said at least one removable grinding stone is driven by means of at least one motor positioned inside said nail grinder body portion, and wherein said at least one motor is powered by an external power supply connected to said at least one motor by means of a power chord.

13. The nail grinder of claim 9, wherein said at least one nail grinding stone comprises at least one of sand, aluminum oxide, ceramic, silicon carbide, or zirconium oxide.

14. The nail grinder of claim 1, further comprising a clip for removably attaching said at least one grinding stone by means of a cylindrical metallic pin.

15. The nail grinder of claim 14, wherein said cylindrical metallic pin is removably attached to a shaft of at least one motor positioned inside said nail grinder body portion, and wherein rotation of said shaft rotates said cylindrical metallic pin that causes rotation of said at least one grinding stone.
